(19) United States
(12) Patent Application Publication
(10) Pub. No.: US 2008/0165716 A1
(43) Pub. Date: Jul. 10, 2008

(54) Sleep Mode Driving Method for Portable Terminal

(75) Inventors: Yong-Seouk Choi, Daejeon-city (KR); June-Bae Seo, Daejeon-city (KR); Nam-Hoon Park, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: ELECTRONICS AND TELECOMMUNICATIONS RESEARCH INSTIT, Daejeon (KR); SAMSUNG ELECTRONICS CO., LTD., Suwon-si (KR); KT CORPORATION, Seongnam-city (KR); SK TELECOM CO., LTD., Seoul (KR); KTFREETEL CO., LTD., Seoul (KR); HANARO TELECOM, INC., Seoul (KR)

(21) Appl. No.: 11/791,062

(22) PCT Filed: Jun. 24, 2005
(86) PCT No.: PCT/KR05/01982

§ 371 Date: May 18, 2007

(30) Foreign Application Priority Data
Nov. 30, 2004 (KR) 10-2004-0099147

(51) Int. Cl. H04Q 7/32

(52) U.S. Cl. 370/311

(57) ABSTRACT

The advantage of the present invention is to provide a sleep mode driving method for reducing power consumption of a portable terminal in a portable Internet system, and to provide the method for the portable terminal to shift into a sleep mode or an awake mode without loss of transmitting and receiving traffic. The portable terminal transmits a sleep mode request message SLP-REQ to the base station, and receives a sleep mode response message SLP-RSP from the base station, so that it can shift to the sleep mode. The portable terminal receives a traffic indication message TRF-IND from the base station during the sleep mode, and shifts to the awake mode. The portable terminal transmits a wake up information message WKUP-INF informing of a normal operation state, and receives downlink traffic from the base station.

### TECHNICAL FIELD

The present invention relates to a portable Internet system, and more particularly, it relates to a driving method for reducing power consumption of a portable terminal in a portable Internet system.

### BACKGROUND ART

High speed Portable Internet (HPI) is a system for a portable Internet network, being developed by Korean technology, that has a structure for providing a high speed Internet service through a wireless connection.

In the portable Internet system, a base station provides the high speed Internet service to a portable terminal through a wireless connection. This has a disadvantage in that power consumption is high since the portable terminal needs to be maintained in a power-on state for a wireless connection with the base station.

To solve this problem, a driving method for refusing a message during a pre-determined period according to a user's choice has been disclosed. This driving method can reduce power consumption, but cannot receive any messages during the period chosen by the user.

In another method, a control method is disclosed wherein a portable terminal switches to a sleep mode in which only a signal channel for a communication module is maintained when a communication module is performing a communication with an external device, and switches to an awake mode in which the portable terminal controls the signal process of the input unit and the output unit when the communication end signal is received from the communication module. This method provides a reduction of power consumption by switching elements that are not needed for communication to a sleep mode when a portable terminal enters a communication mode, and also extends a recharge period of a portable battery. However, the method can reduce power consumption only when the terminal is connected with an external device. Moreover, the method cannot be actively performed in accordance with the existence of transmitting and receiving traffic.

Therefore, a portable terminal driving method for reducing power consumption effectively by switching to a sleep mode or an awake mode according to the existence of transmitting and receiving traffic is required.

The information disclosed in this Background of the Invention section is only for enhancement of understanding of the background of the invention, and therefore, unless explicitly described to the contrary, it should not be taken as an acknowledgement or any form of suggestion that this information forms the prior art that is already known in this country to a person of ordinary skill in the art.

### DISCLOSURE OF INVENTION

### Technical Problem

The present invention has been made in an effort to provide a sleep mode driving method for a portable terminal and a communication method for a base station with a portable terminal.

The advantage of the present invention is to provide a sleep mode driving method for reducing power consumption of a portable terminal in a portable Internet system, and to provide the method for the portable terminal to shift into sleep mode or awake mode without loss of transmitting and receiving traffic.

### Technical Solution

According to an exemplary embodiment of the present invention, a sleep mode driving method for a portable terminal connected wirelessly with a base station includes: a) receiving a traffic indication message (TRF-IND) from the base station during a sleep mode and shifting to an awake mode; b) transmitting a wake up information message (WKUP-INF), which informs that the portable terminal is in a normal operation state, to the base station; and c) receiving a downlink traffic from the base station.

In another embodiment, the sleep mode driving method further includes: a-1) transmitting a sleep mode request message (SLP-REQ) to the base station; and a-2) receiving a sleep mode response message (SLP-RSP) in response to the SLP-REQ from the base station and shifting to the sleep mode, before the step a) above.

In a further embodiment, the sleep mode driving method further includes shifting to the sleep mode by turning off elements that are included in the portable terminal, and shifting to the awake mode by turning on the elements.

In a still further embodiment, in the step a), the TRF-IND includes uplink bandwidth allocation information.

In a still further embodiment, the sleep mode driving method further includes: d) transmitting uplink traffic to the base station according to the bandwidth allocation information, after the step c).

According to an exemplary embodiment of the present invention, a communication method of a base station that is wirelessly connected with a portable terminal in a sleep mode, for transmitting and receiving a traffic, includes: a) transmitting a traffic indication message (TRF-IND) informing of a downlink traffic to the portable terminal; b) receiving a wake up information message (WKUP-INF), which informs that the portable terminal has shifted to an awake mode and is in a normal operation state, from the portable terminal; and c) transmitting the downlink traffic to the portable terminal.

In another embodiment, the communication method further includes: a-1) receiving a sleep mode request message (SLP-REQ) from the portable terminal, and transmitting a sleep mode response message (SLP-RSP), allowing the sleep mode, to the portable terminal, before the step a).

In a further embodiment, in the step a), the TRF-IND comprises uplink bandwidth allocation information.

In a still further embodiment, the communication method further includes receiving the uplink traffic form the portable terminal, after the step c).

### ADVANTAGEOUS EFFECTS

According to the sleep mode driving method of the embodiment of the present invention, the portable terminal receives the TRF-IND from the base station, and transmits the WKUP-INF, which informs that the portable terminal shifted to the awake mode, to the base station. Therefore, the base station becomes aware that the portable terminal is operating in the awake mode.

Therefore, the base station can avoid a loss of traffic by transmitting the traffic after confirming that the portable terminal is operating in the awake state.

The time delay can be reduced, and the buffer management of the base station can be improved, because the bandwidth request process can be skipped after receiving the downlink traffic by previously transmitting the TRF-IND including the bandwidth allocation information.

### BRIEF DESCRIPTION OF THE DRAWINGS

FIG. 1 shows a rough structure of a portable terminal according to an embodiment of the present invention.

FIG. 2 shows a flowchart of a sleep mode driving method according to the first embodiment of the present invention.

FIG. 3 is a diagram for showing a length of a sleep interval.

FIG. 4 shows a flowchart of a sleep mode driving method according to the second embodiment of the present invention.

### BEST MODE FOR CARRYING OUT THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature, and not restrictive.

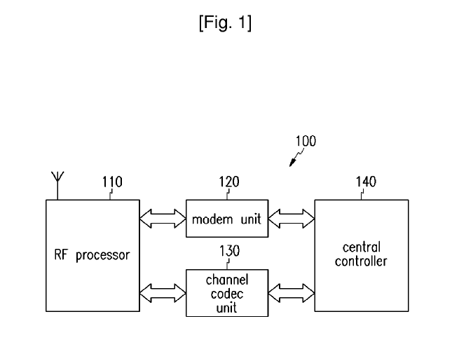

FIG. 1 shows a structure of a portable terminal according to an embodiment of the present invention.

The portable terminal includes an RF processor 110, a modem 120, a channel codec 130, and a central controller 140.

The central controller 140 functions as a main control board controlling various functions of the portable terminal. The central controller 140 controls a sleep mode function of the terminal.

The modem 120 functions as a modulator and demodulator of a received signal.

The channel codec 130 functions as a coder for each channel and as an error processor.

The RF processor 110 transforms the signals into radio signals and transmits them, and receives radio signals from a base station.

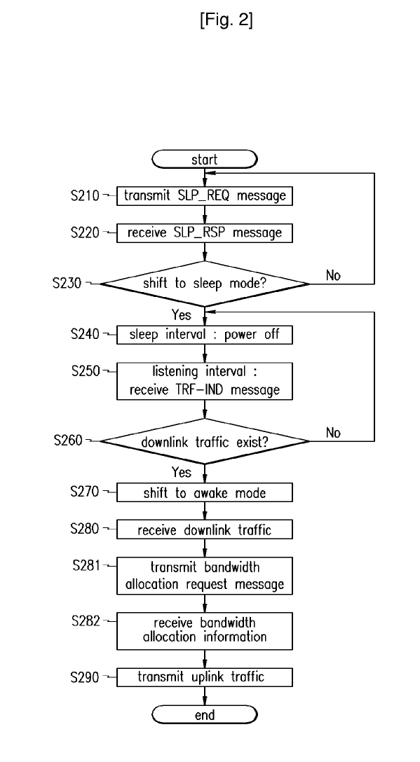

FIG. 2 shows a flowchart of a sleep mode driving method according to the first embodiment of the present invention.

The portable Internet system supports a sleep mode operation to reduce power consumption of the terminal. The sleep mode operation begins when the terminal transmits and receives no traffic for a predetermined time. The terminal transmits a sleep mode request message SLP-REQ to a base station to start the sleep mode operation in step S210.

On receiving the SLP-REQ message, the base station transmits a sleep mode response message SLP-RSP for informing whether to allow the request according to the existence of downlink traffic and a sleep mode terminal control rule of the base station in step S220.

The terminal that received the response message determines whether to start the sleep mode operation according to the response, and the terminal starts the sleep mode operation in step S230 when the terminal received an allowance message from the base station.

The sleep mode includes a sleep interval and a listening interval. In the sleep interval, the terminal enters a sleep state, which represents that the modem 120, the channel codec 130, and the RF processor 110 of the portable terminal are in power-off state, in step S240.

The terminal starts the listening interval in order to receive a traffic indication message TRF-IND for informing the corresponding terminal of the existence of downlink traffic during the sleep interval, when the sleep interval has been finished in step S250. The terminal controls the modem 120 and the RF processor 110 to be in a power-on state in order to receive the TRF-IND message when the listening interval starts.

The portable terminal recognizes the existence of the downlink traffic to be transmitted to the portable terminal according to the TRF-IND message received during the listening interval in step S260.

The portable terminal enters the sleep interval again when the same has no downlink traffic, in step S240.

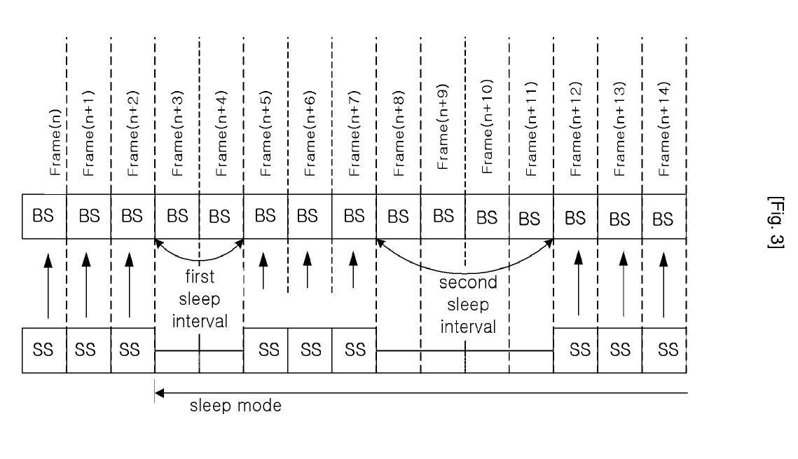

FIG. 3 is a diagram for showing a length of a sleep interval.

As shown in FIG. 3, the length of the second sleep interval, which begins after the first sleep interval and the listening interval, is twice the length of the first sleep interval because it is exponentially increased.

The portable terminal repeats the above process while there is no traffic to be transmitted to the terminal in the sleep mode. The portable terminal finishes the sleep mode automatically, shifts to the awake mode, turns on the elements of the terminal, and starts a normal operation when the length of the sleep interval reaches a maximum.

As shown in FIG. 2, when downlink traffic exists in the step S260, the portable terminal wakes up, and shifts from the sleep mode to the awake mode in step SS270.

The portable terminal receives the downlink traffic from the base station in step S280. Generally, when a terminal has downlink traffic, corresponding uplink traffic is generated.

Therefore, the portable terminal sends a bandwidth request message to the base station for transmitting the uplink traffic in response to the downlink traffic in step S281 after receiving the downlink traffic. The portable terminal sends the bandwidth request message, including a bandwidth request CDMA code, by a random access method.

The portable terminal receives bandwidth allocation information in response to the bandwidth request message in step S282, and transmits actual uplink traffic according to the received bandwidth allocation information in step S290.

However, a transient can occur for several frames in synchronization with the base station, due to a time delay created during the process in which the portable terminal shifts from the sleep interval to the listening interval and turns on the units.

The time delay can be varied according to the characteristics of each terminal. However, it is difficult for the base station, which controls all the terminals in a service cell, to consider each characteristic of the terminals that wake up from a sleep state. The base station transmits the downlink traffic in consideration of the average time delay of the terminals after transmitting a traffic indication message (TRF-IND), because the base station cannot verify whether the portable terminal is in the awake state. When the portable terminal has not received a TRF-IND, or the portable terminal has not reached the normal operation state after shifting to the awake mode though it received the TRF-IND, the portable terminal cannot receive the downlink traffic from the base station, and the downlink traffic can be lost.

The time delay occurs for transmitting the uplink traffic since the portable terminal requests a bandwidth allocation for an uplink after receiving the downlink traffic.

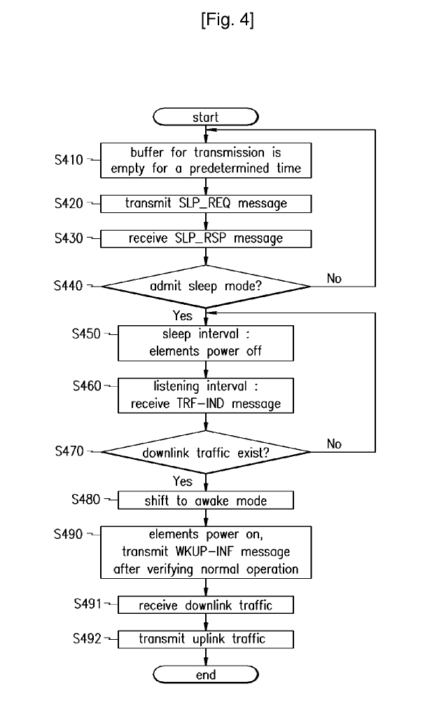

To solve these problems, the sleep mode driving method for the portable terminal according to a second embodiment of the present invention will be described referring to FIG. 4.

FIG. 4 shows a flowchart of a sleep mode driving method according to the second embodiment of the present invention.

The central controller 140 determines whether a state with no transmitting and receiving traffic continues for a predetermined time, that is to say, it determines whether a buffer for transmitting and receiving in the central controller 140 is continuously empty in step S410.

When the buffer is empty for a predetermined time, the central controller 140 generates a sleep mode request message for requesting the sleep mode to the base station, and transmits the SLP-REQ to the base station through the modem 120, the channel codec 130, and the RF processor 110, in order to reduce power consumption, in step S420.

The base station that received the SLP-REQ examines the downlink traffic to be transmitted to the portable terminal and the buffer management state of the base station, and transmits a sleep mode response message SLP-RSP, including information of allowance or refusal for the sleep mode, to the portable terminal. The portable terminal receives the SLP-RSP from the base station in step S430.

The portable terminal determines whether the request for the sleep mode is allowed or refused according to the SLP-RSP in step S440.

The portable terminal shifts to the sleep mode, and starts a sleep mode operation, when the base station allows the sleep mode of the portable terminal through the SLP-RSP. The central controller 140 turns off the modem 120, the channel codec 130, and the RF processor 110, in step S450, when the sleep mode starts.

When the sleep interval ends and the listening interval starts, the portable terminal receives a traffic indication message TRF-IND, which informs of downlink traffic to be transmitted, in step S460. The TRF-IND includes uplink bandwidth allocation information on a pre-allocated uplink bandwidth for the portable terminal.

The central controller 140 analyzes the received TRF-IND, checks whether the downlink traffic to be received is buffered, and determines whether to enter the sleep interval again or shift to the awake mode for receiving the downlink traffic according to the result, in step S470.

The portable terminal enters the sleep interval, and turns off the modem 120, the channel codec 130, and the RF processor 110 again when there are no traffic data to be received. At this moment, the length of the sleep interval is exponentially increased with reference to the first sleep interval, in step S450.

On the other hand, the central controller 140 turns on the modem 120, the channel codec 130, and the RF processor 110, and shifts to the awake mode, in step S480, when there is downlink traffic to be received.

The portable terminal transmits a wake up inform message WKUP-INF, that informs of a shift from the sleep mode to the awake mode, to the base station in step S490.

The base station transmits the buffered downlink traffic to the portable terminal after receiving the WKUP-INF. In detail, the base station can start a traffic transmission after it becomes aware that the terminal in the sleep mode shifts to the awake mode in which normal transmission and receiving is possible.

The portable terminal can transmit the uplink traffic corresponding to the downlink traffic by referring to the uplink bandwidth allocation information included in the TRF-IND in step S492, after receiving the downlink traffic from the base station in step S491.

According to the sleep mode driving method of the second embodiment of the present invention, the portable terminal receives the TRF-IND from the base station, and transmits the WKUP-INF, which informs that the portable terminal has shifted to the awake mode, to the base station. So, the base station becomes aware that the portable terminal is operating in the awake mode, and therefore, the base station can avoid a loss of traffic by transmitting the traffic after confirming that the portable terminal is operating in the awake state.

Additionally, the portable terminal can be in the state of receiving the uplink bandwidth allocation at the moment of receiving the TRF-IND from the base station, because the TRF-IND message includes information of a previously allocated uplink bandwidth for the terminal.

Therefore, the time delay can be reduced by skipping a bandwidth request process for transmitting the uplink traffic after receiving the buffered downlink traffic from the base station.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the sleep mode driving method of the second embodiment of the present invention, the portable terminal receives the TRF-IND from the base station, and transmits the WKUP-INF, which informs that the portable terminal has shifted to the awake mode, to the base station. So, the base station becomes aware that the portable terminal is operating in the awake mode.

Therefore, the base station can avoid a loss of traffic by transmitting the traffic after confirming that the portable terminal is operating in the awake state.

The time delay can be reduced, and the buffer management of the base station can be improved, because the bandwidth request process can be skipped after receiving the downlink traffic by previously transmitting the TRF-IND including the bandwidth allocation information.

1. A sleep mode driving method for a portable terminal connected wirelessly with a base station, the method comprising:
a) receiving a traffic indication message (TRF-IND) from the base station during a sleep mode and shifting to an awake mode;
b) transmitting a wake up information message (WKUP-INF), which informs that the portable terminal is in a normal operation state, to the base station; and
c) receiving downlink traffic from the base station.

2. The sleep mode driving method of claim 1, wherein the method further comprises, before the step a):
a-1) transmitting a sleep mode request message (SLP-REQ) to the base station; and
a-2) receiving a sleep mode response message (SLP-RSP) in response to the SLP-REQ from the base station, and shifting to the sleep mode.

3. The sleep mode driving method of claim 2, wherein the method further comprises shifting to the sleep mode by turning off elements that are comprised in the portable terminal, and shifting to the awake mode by turning on the elements.

4. The sleep mode driving method of claim 1, wherein in the step a), the TRF-IND comprises uplink bandwidth allocation information.

5. The sleep mode driving method of claim 4, wherein, after the step c), the method further comprises,
d) transmitting uplink traffic to the base station according to the bandwidth allocation information.

6. A communication method for a base station to wirelessly connect to a portable terminal in a sleep mode, and transmit and receive traffic, the method comprising:
a) transmitting a traffic indication message (TRF-IND) informing of downlink traffic to the portable terminal;
b) receiving a wake up information message (WKUP-INF), which informs that the portable terminal has shifted to an awake mode and is in a normal operation state, from the portable terminal; and
c) transmitting the downlink traffic to the portable terminal.

7. The communication method of claim 6, wherein, before the step a), the method further comprises:
a-1) receiving a sleep mode request message (SLP-REQ) from the portable terminal, and transmitting a sleep mode response message (SLP-RSP), allowing the sleep mode, to the portable terminal.

8. The communication method of claim 6, wherein, in the step a), the TRF-IND comprises uplink bandwidth allocation information.

9. The communication method of claim 8, wherein, after the step c), the method further comprises receiving uplink traffic form the portable terminal.
